(19) United States
(12) Patent Application Publication
(10) Pub. No.: US 2022/0305843 A1
(43) Pub. Date: Sep. 29, 2022

(54) COMPOSITE WHEEL HAVING CONTINUOUS REINFORCING PLY FROM SPOKE-TO-SPOKE AND SPOKE-TO-BARREL

(71) Applicant: ESE Carbon, Inc., Jasper, GA (US)

(72) Inventors: Carlos Hermida, Jasper, GA (US); Tyler Haase, Japser, GA (US); Michael Hayes, Jasper, GA (US); Thomas Leonard, Jasper, GA (US); Gert Oosthuizen, Jasper, GA (US)

(73) Assignee: ESE Carbon, Inc., Jasper, GA (US)

(21) Appl. No.: 17/215,806

(22) Filed: Mar. 29, 2021

(51) Int. Cl. B60B 5/02; B60B 3/10

(52) U.S. Cl. CPC B60B 5/02; B60B 3/10; B60B 2360/348; B60B 2360/3416; B60B 2360/3424

(57) ABSTRACT

A fiber-reinforced composite wheel for a road vehicle includes a rim and a mount integrally joined to the barrel by spokes, wherein the wheel includes a continuous ply of reinforcing fiber fabric extending through a first spoke, through at least a portion of the mount, and through another spoke of the wheel to provide improved strength, durability and integrity to the wheel.

### FIELD OF THE DISCLOSURE

This disclosure relates to composite wheels, and more specifically to wheels comprising fiber reinforced thermoset composites.

### BACKGROUND OF THE DISCLOSURE

Fiber-reinforced composite wheels have been recognized for providing performance advantages for road vehicles due to their relatively light weight and reduced rotational inertia. This reduction in rotational inertia and mass (or weight) results in significantly faster acceleration, reduced braking distance, improved handling, the ability to reduce unsprung mass (e.g., the mass of other suspension components such as axles and wheel bearings), and reduced road noise. As a result, fiber-reinforced wheels are widely used in luxury vehicles and sports cars, and are beginning to appear on lower priced vehicles.

Notwithstanding the significant advantages associated with fiber-reinforced composite wheels as compared to steel and metal alloy wheels, there remains a need for structures that provide improved mechanical properties as compared with currently available fiber-reinforced composite wheels.

### SUMMARY OF THE DISCLOSURE

It has been discovered that improved structural integrity can be achieved in a fiber-reinforced composite wheel by laying fiber plies during wheel fabrication such that at least one of the plies in the completed wheel is continuous from one spoke, through the hub, and through another spoke.

It has also been discovered that improved strength and resistance to wheel damage during high stress cornering or in the event of impact with a curb or pot-hole can be achieved in a fiber-reinforced composite wheel having a barrel and a mount, by laying plies during fabrication such that the plies in the completed wheel extends continuously through at least a portion of a spoke and through at least a portion of the barrel.

### BRIEF DESCRIPTION OF THE DRAWINGS

FIG. 1 is a perspective view of a fiber-reinforced composite wheel.

FIG. 2 is a top view of a plurality of fiber plies layed-up on a fixture to form the mount of a fiber-reinforced composite wheel.

FIG. 3 is a side view of a plurality of fiber plies layed-up on a fixture to form a composite wheel in which at least one ply extends continuously through a spoke and through the barrel of the wheel.

FIG. 4 is a top view of the layed-up plies shown in FIG. 2, with at least one ply extending continuously along a spoke and circumferentially along the barrel of the wheel.

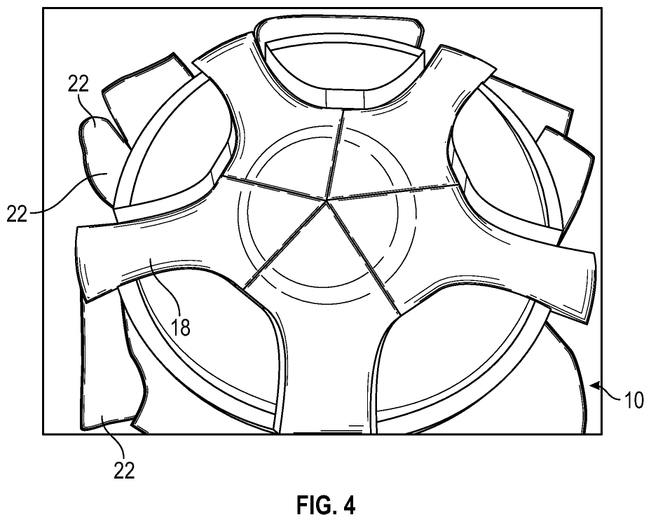

FIG. 5 is a top perspective view of the layed-up plies shown in FIGS. 2 and 3, with an underlying ply being indicated by dashed lines to show an offset between adjacent plies.

### DETAILED DESCRIPTION

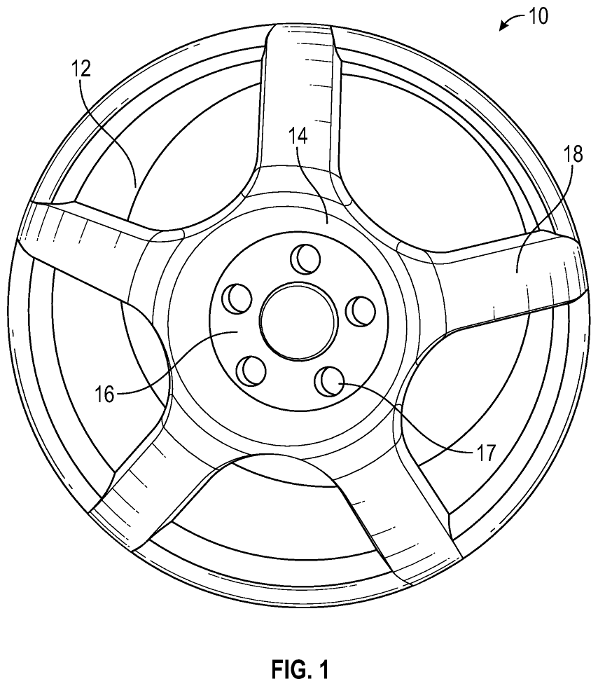

Shown in FIG. 1 is a fiber-reinforced composite wheel 10 that can be fabricated to have the features and advantages of the disclosure. Wheel 10 includes a rim or barrel 12 having a generally cylindrical shape, and a disc or mount 14 comprising a hub section 16 having apertures 17 for attachment to a road vehicle axle hub, and a plurality of spokes 18 connecting the barrel with the mount. The barrel has a ring structure including relatively thicker inboard and outboard flanges (not shown) for mounting a tire and a generally thinner cylindrical section between the flanges.

Wheel 10 is fabricated in a fixture employing known techniques of hand laying or machine laying multiple overlapping plies. The plies are comprised of strong fabric pieces made of fibers that provide reinforcement and strength to the finished wheel. Each ply can consist of one or more fiber tows. A fiber tow is an untwisted bundle of continuous filaments. A tailored fiber placement preform refers to a stitched reinforcing structure made using embroidery machines that precisely stitch fiber roving material onto a base material. The fiber tows and plies can be comprised of glass (e.g., silica-based glass containing metal oxides), boron, aramid, carbon, or other high strength reinforcing fibers. After the layup is completed, the layed-up plies are compressed and sealed in a molding fixture. A thermosetting or thermoplastic resin is injected into the mold, which may be preheated, and the resin is cured or hardened. After the resin has cured (i.e., crosslinked into a bonded state, or solidified in the case of thermoplastic resin), the molded part is demolded, cut and trimmed (e.g., manually or by a robot) to provide a completed wheel 10. Suitable thermosetting resins include unsaturated polyester resins, vinyl ester resins, epoxy resins, phenolic resins, polyurethane resins, and polyamide resins. Examples of thermoplastic resins include polycarbonates, acrylic resins, polyester resins, polyamides and polyurethanes.

The plies (fabric pieces) can be non-woven or randomly oriented fibrous mats, woven fabrics, knitted fabrics, stitched fabrics, tailored fiber placement performs and/or braided fabrics (made by intertwining three or more yarns without any two yarns being twisted around each other).

The plies can be pre-impregnated with a thermosettable or non-thermosettable resin to facilitate assembly.

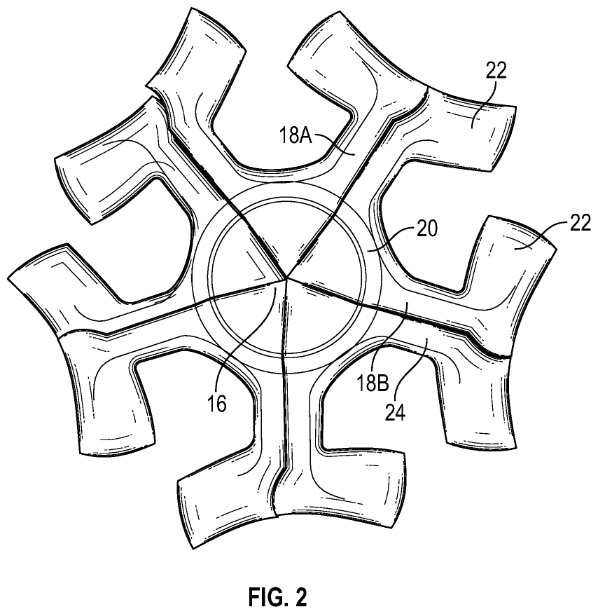

As shown in FIG. 2, the plies 20 can extend continuously through a first spoke 18A, through hub section 16, and through another spoke 18B. In the illustrated layup of FIG. 2, the fabric ply extends from a first spoke 18A, through the hub section, and through an adjacent spoke.

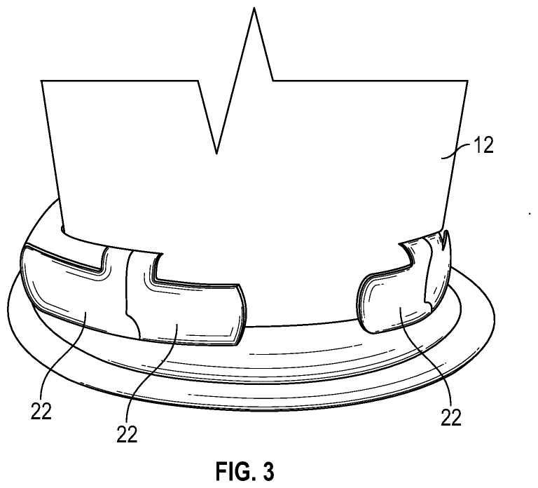

The layed-up plies 20 shown in FIG. 2 also includes radially distal tabs or ears 22 that extend laterally toward each other, and away from the seam 24 between the plies. As shown in FIG. 3, tabs 22 extend circumferentially along barrel 12. Upon compression and injection molding, tabs 22 become fused to, or bonded with, the thin (non-flanged) portion of barrel 12, which can be made of or comprise a braided fabric.

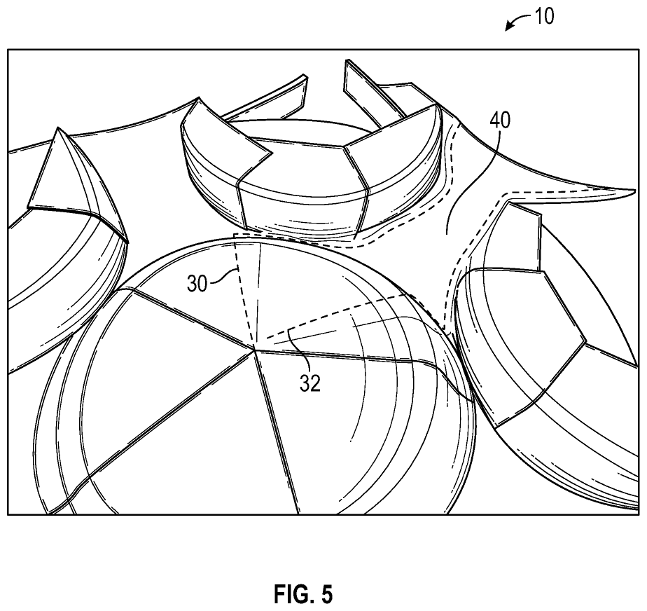

FIG. 5 shows edges 30 of an underlying ply in dashed lines. The edges 30 of the underlying ply are offset from edges 32 of an overlying ply 40. In the preferred embodiments having a plurality of layers (e.g., 10-20 layers or plies), each interior layer has edges offset from an adjacent overlying and underlying layer to reduce or eliminate the possibility of seam separation and/or delamination.

Accordingly, it is to be understood that the above description is intended to be illustrative and not restrictive. Many embodiments and applications other than the examples provided would be apparent upon reading the above description. The scope of the invention should be determined with reference to the appended claims along with the full scope of equivalents to which such claims are entitled. It is anticipated and intended that future developments will occur, and that the disclosed systems and methods will be incorporated into such future embodiments. In summary, it should be understood that the invention is capable of modification and variation.

What is claimed is:

1. A composite wheel, comprising:
a barrel made of fiber-reinforced resin, the barrel having a ring structure including, a substantially cylindrical section;
a mount made of fiber-reinforced resin and integrally joined to the barrel, the mount configured for releasable attachment to a hub flange;
a plurality of spokes extending between the mount and the barrel; and
wherein the composite wheel includes a continuous ply of reinforcing fiber fabric extending through a first spoke, through at least a section of the mount, and through a second spoke.

2. The wheel of claim 1, wherein the composite wheel further comprises a ply of reinforcing fiber fabric extending continuously through a first spoke and through at least a section of the barrel.

3. The wheel of claim 1, wherein the composite wheel has a plurality of overlapping reinforcing fabric plies, each of the plurality of plies having an edge that is offset from an edge of an adjacently overlying or underlying ply.

4. The wheel of claim 1, wherein the fiber-reinforced resin comprises a carbon fiber reinforced thermoset resin.

5. The wheel of claim 1, wherein the fiber-reinforced resin comprises an epoxy resin.

6. The wheel of claim 1, wherein the fibers in the barrel are braided.

7. The wheel of claim 1, wherein the fibers in the mount are tailored fiber placement preforms.

8. A composite wheel, comprising:
a barrel made of fiber-reinforced resin, the barrel having a ring structure including a substantially cylindrical section;
a mount made of fiber-reinforced resin and integrally joined to the barrel, the mount configured for releasable attachment to a hub flange;
a plurality of spokes extending between the mount and the barrel; and
wherein the composite wheel includes a ply of reinforcing fiber fabric extending continuously through a first spoke and through at least a section of the barrel.

9. The wheel of claim 8, wherein the composite wheel has a plurality of overlapping reinforcing fabric plies, each of the plurality of plies having an edge that is offset from an edge of an adjacently overlying or underlying ply.

10. The wheel of claim 8, wherein the fiber-reinforced resin comprises a carbon fiber reinforced thermoset resin.

11. The wheel of claim 8, wherein the fiber-reinforced resin comprises an epoxy resin.

12. The wheel of claim 8, wherein the fibers in the barrel are braided.

13. The wheel of claim 8, wherein the fibers in the mount are tailored fiber placement preforms.

14. A composite wheel, comprising:
a barrel made of fiber-reinforced resin, the barrel having a ring structure including a substantially cylindrical section;
a mount made of fiber-reinforced resin and integrally joined to the barrel, the mount configured for releasable attachment to a hub flange;
a plurality of spokes extending between the mount and the barrel; and
wherein the composite wheel has a plurality of overlapping reinforcing fabric plies, each of the plurality of plies having an edge offset from an edge of an adjacently overlying or underlying ply.

15. The wheel of claim 14, wherein the fiber-reinforced resin comprises a carbon fiber reinforced thermoset resin.

16. The wheel of claim 14, wherein the fiber-reinforced resin comprises an epoxy resin.

17. The wheel of claim 14, wherein the fibers in the barrel are braided.

18. The wheel of claim 14, wherein the fibers in the mount are tailored fiber placement preforms.
